(19) United States
(12) Patent Application Publication
(10) Pub. No.: US 2025/0345790 A1
(43) Pub. Date: Nov. 13, 2025

(54) VERY LARGE SCALE MICROFLUIDIC INTEGRATED CHIP WITH MICRO-PATTERNED WETTABILITY FOR HIGH THROUGHPUT MULTIPLE DROPLET GENERATION

(71) Applicant: THE TRUSTEES OF THE UNIVERSITY OF PENNSYLVANIA, Philadelphia, PA (US)

(72) Inventors: Daeyeon LEE, Wynnewood, PA (US); Jingyu WU, Philadelphia, PA (US); David Aaron ISSADORE, Philadelphia, PA (US); Sagar Prasad YADAVALI, Downingtown, PA (US)

(21) Appl. No.: 18/993,105

(22) PCT Filed: Jul. 11, 2023
(86) PCT No.: PCT/US2023/069941

§ 371 Date: Jan. 10, 2025

Related U.S. Application Data
(60) Provisional application No. 63/368,086, filed on Jul. 11, 2022.

(51) Int. Cl. B01L 3/00

(52) U.S. Cl. CPC B01L 3/502707; B01L 3/502715; B01L 3/502784; B01L 2300/0887; B01L 2300/161

(57) ABSTRACT

Provided is a method of forming a microfluidic component, for example, from glass and/or Si substrates, with the microfluidic component including therein patterned regions of relative hydrophobicity and relative hydrophilicity. Also provided are microfluidic components that include the substrates bonded together, the microfluidic components including therein patterned regions of relative hydrophobicity and relative hydrophilicity. The regions can be on any one or more of a floor, a wall, or a ceiling of a channel of the microfluidic component.

### CROSS-REFERENCE TO RELATED APPLICATIONS

The present application claims priority to and the benefit of U.S. patent application No. 63/368,086, “Very Large Scale Microfluidic Integrated Chip With Micro-Patterned Wettability For High Throughput Multiple Droplet Generation” (filed Jul. 11, 2022). All foregoing applications are incorporated herein by reference in their entireties for any and all purposes.

### GOVERNMENT RIGHTS

This invention was made with government support under HG010023 awarded by the National Institutes of Health. The government has certain rights in the invention.

### TECHNICAL FIELD

The present disclosure relates to the field of microfluidics and to the field of forming hydrophobic patterns on substrates.

### BACKGROUND

To date, it has proven challenging to achieve micrometer-scale patterned fluidic channels and also micrometer-scale patterned wetting properties in microfluidic devices. This control of wettability is necessary to maintain the stability of the multi-order emulsions in the channel as they are sequentially fabricated. As an example, to produce a water-in-oil-in-water (W/O/W) emulsion, hydrophobic channels ensure the dispersed phase does not wet the channel in the region of the chip where the W/O emulsion is formed. Downstream, hydrophilic channels ensure the outer oil phase of the W/O/W double emulsion does not wet the channel.

Unfortunately, current methods to pattern wettability suffer from low spatial resolution, do not allow for arbitrary patterning, and are thus not compatible with chips that incorporate large numbers of parallelized devices. These limitations have made it challenging to translate the many promising multi-order emulsions demonstrated in microfluidic devices in laboratory settings to commercial and medical applications. Accordingly, there is a long-felt need in the art for improved methods of achieving patterned wetting properties in microfluidic devices.

### SUMMARY

In meeting the described needs, the present disclosure provides a method of forming a microfluidic component, comprising: disposing an agent onto at least a portion of a first substrate so as to define at least one relatively hydrophobic region on the first substrate, the first substrate comprising at least one of silicon and glass, the at least one relatively hydrophobic region of the first substrate having an initial hydrophobicity; anodically bonding the first substrate and a second substrate so as to give rise to the microfluidic component, the second substrate comprising at least one of silicon and glass and the bonding being performed under such conditions that that the at least one relatively hydrophobic region of the first substrate retains at least some of its initial hydrophobicity.

Also provided is includes a microfluidic component made according to the described methods.

Also presented is a microfluidic component, comprising: a first substrate, the first substrate optionally comprising silicon, the first substrate having a feature formed therein, the feature optionally comprising a channel, and the feature having at least one region that is relatively hydrophobic relative to the first substrate; a second substrate, the second substrate being bonded to the first substrate, the second substrate optionally comprising glass, the second substrate having at least one region that is relatively hydrophobic relative to the second substrate, and the relatively hydrophobic region of the first substrate facing the relatively hydrophobic region of the second substrate.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIGS. 1A-1F illustrate wettability patterning for high-throughput double emulsion generation. (FIG. 1A) A step-by-step fabrication workflow for wettability patterning in Si/glass. (FIG. 1B) SEM image of lithographically exposed parallel microfluidic channels with areas covered with photoresist (dark) and areas with native surfaces (bright). Scale bar: 500 μm (FIG. 1C) A schematic of the wettability patterning, and channel geometry, for single-channel double emulsion generator for both W//O/W and O/W/O emulsion generation. (FIG. 1D) A schematic for a parallelized 50 channel device for W/O/W emulsion generation. (FIG. 1E) A micrograph of the generation of water/hexane/water double emulsions being generated in the 50-channel device. Scale bar: 150 μm, (FIG. 1F) W/O/W double emulsion droplets collected from 50-channel device. Scale bar: 100 μm.

FIGS. 2A-2D provide example characterization of wettability patterning. (FIG. 2A) A micrograph of the side-view of a water droplet in hexane on a native silicon surface and on a PFOCTS-treated silicon surface. Scale bar: 200 μm (FIG. 2B) Water-in-hexane contact angle measurements under various fabrication-related conditions. (FIG. 2C) A micrograh of micro-patterned wettability test structure in the presence of water vapor. The hydrophilic regions condense water. Scale bar: 100 μm. (FIG. 2D) SEM image of lithographically patterned PFOCTS on a droplet generator chip. Scale bar: 100 μm.

FIGS. 3A-3D provide example illustration of single-channel double emulsion generation. (FIG. 3A) Schematic of a double-emulsion generator in drip-drip mode. (FIG. 3B) SEM images of channel junctions before silane functionalization with first junction revealed native surface and second junction covered by photoresist. Scale bar: 10 μm. (FIG. 3C) Microscopic image of water in hexane in water double emulsion generation. Scale bar: 150 μm. (D) Collected double emulsions. Scale bar: 50 μm. (FIG. 3D) Histogram of the collected double emulsions.

FIGS. 4A-4G illustrate example double emulsion generation in a parallelized device. (FIG. 4A) Photograph of a 4-inch chip containing 12 identical 50-channel devices. (FIG. 4B) Schematic of a 50 channel double emulsion chip. (FIG. 4C) Microscopic of parallel generation of water in hexane in water double emulsions. Sacle bar: 150 μm (FIG. 4D) Zoom-in fluorescent image of double emulsions entering collection channel. Channels are marked with pseudo colors as visual aid. Scale bar: 100 μm (E) Microscopic image of collected double emulsions. Scale bar: 100 μm (F) Histogram of collected double emulsions (G) Photograph of double emulsions collected in 30 mins in a 50 mL tube.

FIGS. 5A-5B provide example conformal spray coating (FIG. 5A) Microscopic image of microchannel after spray coating (FIG. 5B) SEM image of lithographically exposed wafer with line patterns.

FIGS. 6A-6B provide angled-UV exposure (FIG. 6A) straight exposure (i) Schematic drawing of straight exposure on microchannel covered by photoresist (ii) & (iii) SEM images showing remaining photoresist due to insufficient exposure (FIG. 6B) angled exposure (i) schematic drawing of angled exposure on microchannel covered by photoresist (ii) & (iii) SEM images showing clean channel due to sufficient exposure.

FIGS. 7A-7C provide an example die and holder for microchip operation (FIG. 7A) A single-channel die next to a cent (FIG. 7B) Front view of the chip holder (FIG. 7C) Back view of the chip holder.

FIGS. 8A-8B illustrate hexadecane in water in hexadecane droplet generation (O/W/O) (FIG. 8A) Single-channel O/W/O double emulsion generator (FIG. 8B) Collected O/W/O double emulsions.

FIG. 9 provides a close-up SEM image of an example flow resistor. Scale bar: 100 μm.

FIGS. 10A-10B provide example marks for alignment. (FIG. 10A) (i) alignment marks on silicon wafer (ii) alignment marks on glass wafer (FIG. 10B) Microscopic image of alignment marks on bonded chip. The deviation between silicon and glass is 100 μm. Scale bar is 100 μm.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

The wetting properties of microfluidic channels play an essential role in applications such as generating multiple emulsions, stabilizing multi-phase flows, inducing phase inversion of emulsions, and controlling adsorption of proteins. There have been examples of using microfluidics with spatially controlled wetting properties to generate “designer microparticles” with precisely controlled internal structure, which have demonstrated uniquely advantageous functionality for fields such as drug delivery, single cell analysis, separations, and lightweight materials. However, the synthesis of these complex microparticles has been mostly limited to single-channel operation that has inherently low production rates (<10 mL/hr). A few recent studies demonstrated complex microparticle production with parallelized microchips, but these methods require either reinjection of emulsions between two chips, which limits the choices of formulations and compromises emulsion uniformity, or manual assembly of multiple pretreated devices, which has limited channel resolution (>300 μm). For microparticles that require only single emulsion templates, this low throughput problem has been addressed by developing architectures that incorporate many microfluidic droplet generators onto a single chip that operate in parallel.

To date, however, it has proven challenging to apply parallelization approaches to the generation of multiple emulsions because these chips require both micrometer-scale fluidic channels and micrometer-scale patterned wetting properties. This control of wettability is necessary to maintain the stability of the multiple emulsions in the channel as they are produced. For instance, to produce a water-in-oil-in-water (W/O/W) emulsion, hydrophobic channels ensure the dispersed phase does not wet the channel in the region of the chip where the W/O emulsion is formed. Downstream, hydrophilic channels ensure the oil phase of the W/O/W double emulsion does not wet the channel. Unfortunately, current methods to pattern wettability suffer from low spatial resolution (>100 μm), do not allow for arbitrary patterning, and are thus not compatible with chips that incorporate large numbers of parallelized devices with three-dimensional architecture. These limitations have hindered translation of the many promising multiple emu lsion-based materials demonstrated in microfluidic devices in laboratory settings to commercial and medical applications.

The existing methods for patterning the wettability of a microfluidic device can be divided into two categories: 1) those that are implemented on a fully formed device, and 2) those that implement wettability patterning before the multiple substrates that form the device are assembled. For the first category, several methods have been developed to pattern wetting properties in microfluidic devices by flowing reagents through the selected regions of the devices, including coating polyelectrolytes-containing fluids in PDMS channels, coating a photo-reactive layer on PDMS with a sol-gel precursor, or using oxygen plasma to render PDMS channels temporarily hydrophilic. Spatial control in these methods is generally limited by the ability to direct the flow of a fluid to a particular region of the chip and not to others. To improve spatial resolution, some have fabricated devices out of separate components that can be pre-treated to define their hydrophobicity. One component of the device is surface treated with one chemistry while the other components are treated with a different chemistry, or remain untreated, and the components are subsequently assembled to define droplet generators. While successful for laboratory demonstrations, these approaches are not easily compatible with massive parallelization (N>100 devices), due to the impracticality of assembling and building instrumentation for hundreds of separate devices. Alternatively, hydrophobicity can be patterned using lithographic methods-allowing arbitrary control of the patterning to the micro-scale. However, previously reported techniques have been compatible with only planar surfaces and have not been adapted to pattern the three-dimensional channels that constitute microfluidic chips.

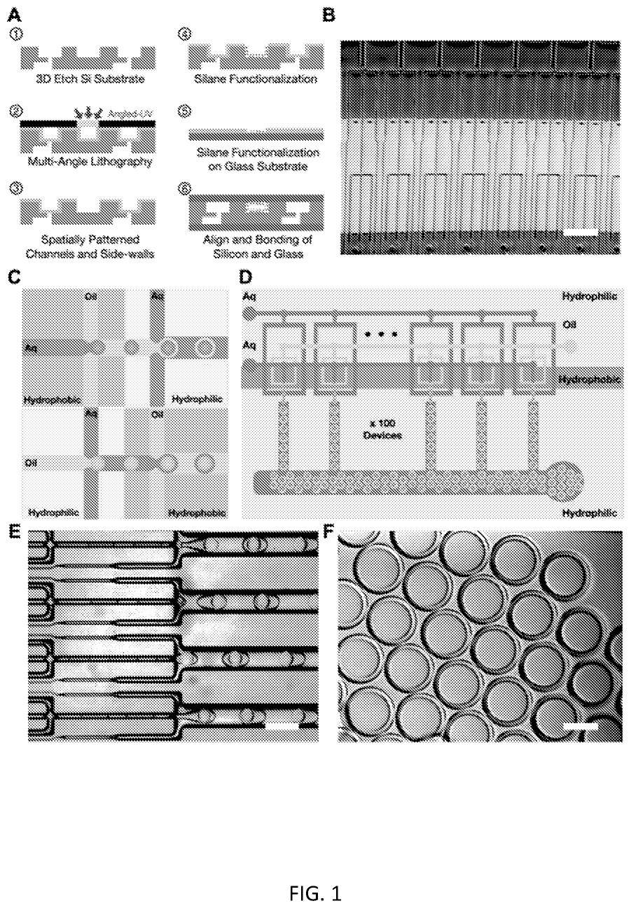

To address these issues, we develop a method to lithographically define micrometer-scale resolution patterns of wettability on all channel surfaces-ceiling, floor, and walls. Although this technology is demonstrated in a non-limiting silicon and glass (Si/glass) microfluidic device over an entire 4-inch wafer (FIG. 1A), it should be understood that this approach is not limited to the Si/glass devices described here, as such devices are illustrative only and do not limit the scope of the disclosed technology.

To demonstrate the utility of this approach, we fabricate an all silicon and glass very large-scale microfluidic integration (VLSMI) chip that can generate precise multiple emulsions at high throughput. Our VLSMI chip incorporates arrays of microfluidic double emulsion droplet generators onto a 3D-etched single silicon wafer, where each generator has precisely patterned hydrophobic and hydrophilic regions. (FIG. 1B & 1C) Both the silicon and the glass are patterned lithographically with a silane before they are anodically bonded together. To ensure that the patterned hydrophobic regions on Si and glass wafers survive the fabrication process, a silane with high stability is chosen and, more importantly, the fabrication process is adapted to accommodate silanization. To ensures that the sidewalls of the channel are successfully patterned, in addition to the channel floors and ceilings, we use angled illumination when lithographically patterning the silicon microfluidic device. We demonstrate that this technique can be used to fabricate 4″ wafers that incorporate 12 units, each unit containing 50 double emulsion generators, each with a precisely defined hydrophilic and hydrophobic regions, with 100% yield. (FIG. 1D).

To demonstrate the modularity of the approach, we perform hydrophobic patterning in a configuration for both O/W/O and W/O/W double emulsion generation. Using these chips, we generated double emulsions with inner diameters that could be controlled over a range from 65 to 72 μm and outer diameters with a range of 85 to 95 μm. We demonstrated that a chip with 50 parallel generators precisely produces double emulsions with exceptionally high monodispersity (CV<5% for both the inner and outer diameters) at high throughputs (50 million double emulsions per hour, 50× faster than possible with a single device). (FIG. 1E & 1F) Beyond the example of double emulsions generated in this manuscript, we envision that this technology will find broad utility of high-resolution patterning of wettability for applications that require stabilized flows of immiscible fluids such as lock-release lithography and the incorporation of functionalities such as phase inversion emulsification (PIE) to generate highly viscous emulsions.

### Results & Discussion

To lithographically pattern the wettability of our VLSMI chip, one step was to identify a silane that could survive the VLSMI fabrication process. The VLSMI chips are fabricated from a single 4″ wafer of 500 μm thick Si, using multiple steps of lithography and deep reactive ion etching (DRIE). In this work, we use lithography to pattern the silanization on both the glass and Si wafers immediately before the two substrates are bonded together using anodic bonding. (FIG. 1A) Anodic bonding is typically performed at temperatures above 350° C., which would degrade most silanes. Moreover, before anodic bonding, both the glass and Si wafer are exposed to harsh chemicals such as acids and solvents to stringently clean the chips necessary for successful bonding. Thus, it is helpful to identify a silane with high thermal and chemical stability and more importantly adapt the fabrication process to be less harsh so that the functionality of our patterned silane could be retained after anodic bonding. This stability requirement for the silane also confers the added benefit of compatibility with use of harsh organic solvents for continuous or dispersed phases and for operation at high temperatures (T≥250° C.).

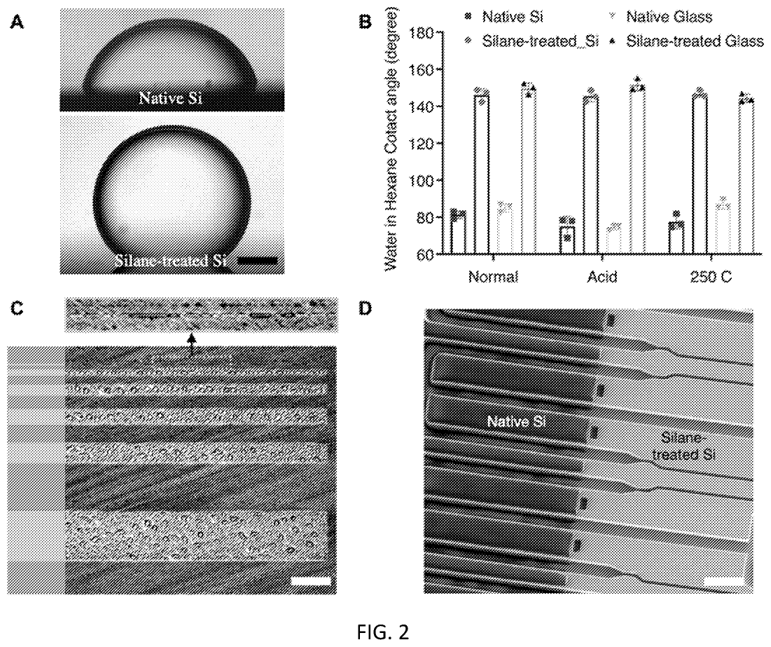

Among the commercially available silane agents, trichloro (1H,1H,2H,2H-perfluorooctyl) silane (PFOCTS) is chosen because it has been shown to have excellent thermal stability, up to ˜270° C. The silane is vapor coated to the silicon/glass substrates in a vacuum chamber for overnight to form a SAM (self-assembly monolayer) on the surfaces. We evaluate the stability of this silane under conditions used in our microchip fabrication. The silanization of both glass and silicon challenged with a piranha acid wash for 30 mins and a high temperature treatment of 250° C. on a hot plate for 30 mins under ambient air. We characterize the stability of the silane by measuring the contact angle of water on the substrates in hexane before and after temperature and acid treatments. For both silicon and glass, contact angle measurements are performed on both native and silane-treated substrates for all conditions. Prior to temperature and acid test, the silane-treated substrates are rendered hydrophobic, with water-in-hexane contact angle of ˜145°. The contact angles show no significant changes after acid treatment and heating at 250° C., indicating compatibility of PFOCTS with our fabrication method. (FIG. 2A, B)

We next evaluated a fabrication process that lithographically patterns the hydrophobicity of the channels with micrometer scale resolution. To this end, we first created a test pattern, wherein we define the hydrophilicity on a silicon wafer using stripes with width ranging from 250 μm to 3 μm. We define the pattern using positive photoresist and then functionalize the lithographically exposed stripes by depositing PFOCTS on the wafer from the vapor phase overnight. After silanization, the photoresist is removed using acetone, IPA, water and nanostrip sequentially to reveal the native hydrophilic surface of silicon. We validate the spatial patterning of wettability by performing a vapor condensation test on the treated wafer; when the wafer is exposed to water vapor generated from a commercial humidifier (Taotronics, TT-AH046), and the stripe pattern becomes visible due to the patterned wetting properties (FIG. 2C). The minimum resolution for patterning the hydrophobicity that we evaluated is 3 μm, which we are able to successfully resolve under an optical microscope. This technique can be applied to sub-micrometer resolution patterning using a technique such as electron beam lithography, which allows photoresist patterning in the nanometer scale.

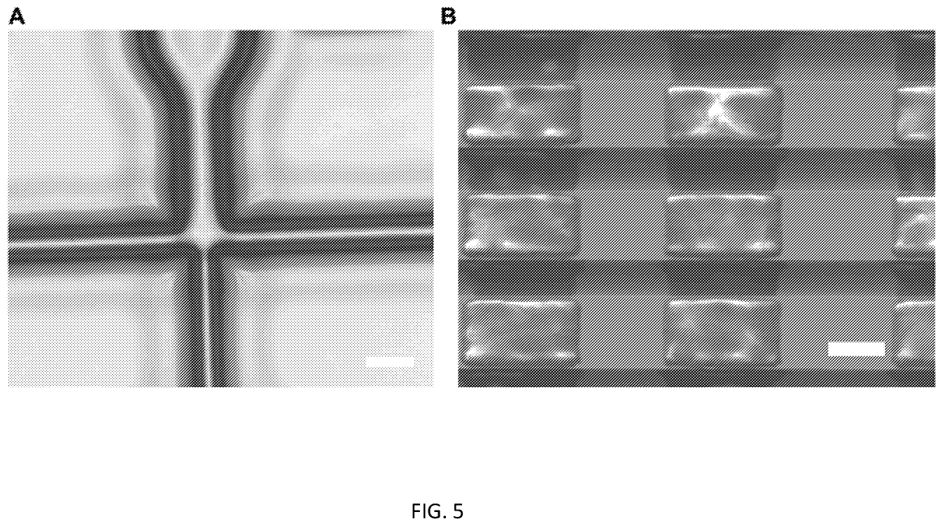

Although these results so far demonstrate that wettability can be patterned on laterally planar surfaces under conditions that would be used conventionally in lithography, it is necessary for VLSMI integration that the vertical sidewalls of rectangular channels be patterned with the silane as well. To address this challenge, we introduce three key innovations:
1) Instead of using spin-coating, as is typically done, we spray coat a positive photoresist S1805 (SUSS Microtech AS8) onto the silicon wafer. Spin coating coats the vertical sidewalls non-uniformly and leads to pooling of the resist in the corner between the channel floor and the sidewalls. In contrast, an optimized spray coating protocol can create uniform coatings of photoresist on the side walls as well as the bottom surface of the channel. (FIG. 5).
2) Instead of using contact UV photolithography, we use a multi-step exposure procedure (FIG. 1A), wherein the chip is angled relative to the direction of the UV illumination to ensure the sidewalls are exposed to a sufficient dose of UV illumination. (FIG. 2D). Angled illumination is useful because the photoresist on the sidewall would not fully develop with normal illumination because UV would have to penetrate through the depth of the channel, which can be tens of micrometers. The photoresist buildup on the bottom corners of the channel makes UV penetration increasingly difficult for deep channels (>50 μm), leading to incomplete and unreliable patterning of wettability.

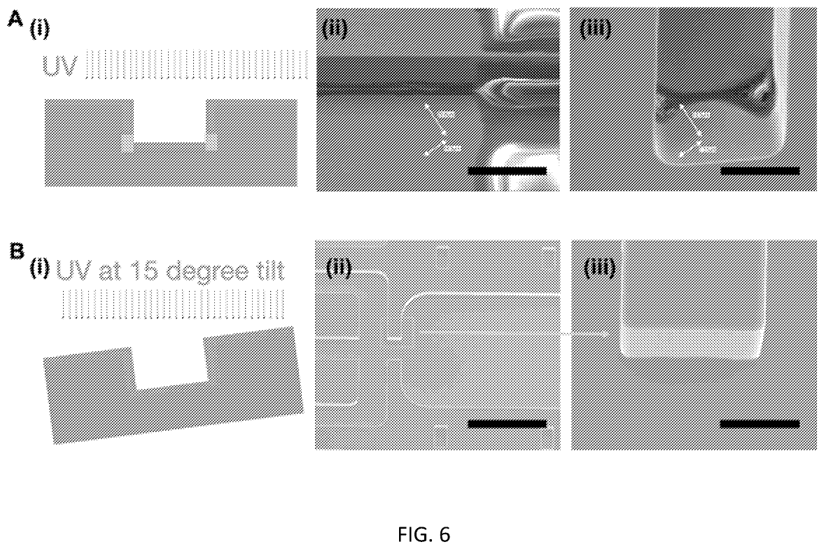

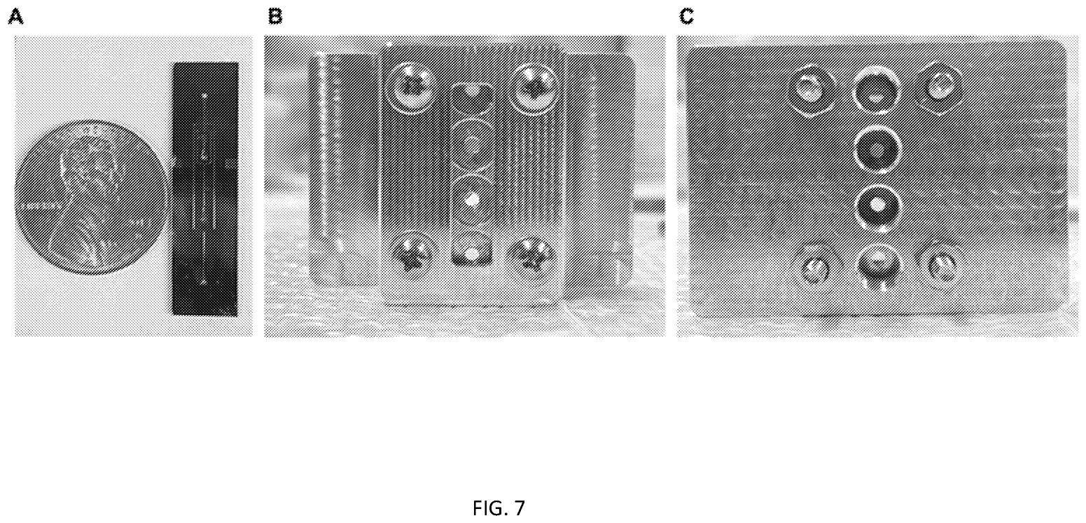

Our angled UV exposure scheme uses a 15° angle offset from the direction normal to the chip's surface, and repeat the same process 4 times, each time with the wafer rotating 90° from its last position on the chuck. This procedure ensures sufficient UV exposure on the photoresist on the side walls and results in clean removal of the photoresist (FIG. 6).
3) To seal the glass and silicon, we anodically bond using a greater than typical applied voltage, 1200V, to allow low-temperature anodic bonding at 250° C. We keep the temperature lower than what is typically used for anodic bonding, 350° C. to 450° C., to preserve the functionality of the silane coating. The drop in temperature lowers the ionic mobility in silicon and glass, and thus to maintain the bonding quality we compensate by applying a high voltage, ensuring sufficient ion displacement during the process. After dicing the Si/glass chip into dies (small chips), each die containing one DEm device with 50 parallel generators, the dies are loaded in a custom machined metal fitting that contains fluidic inlets/outlet connections (FIG. 7).

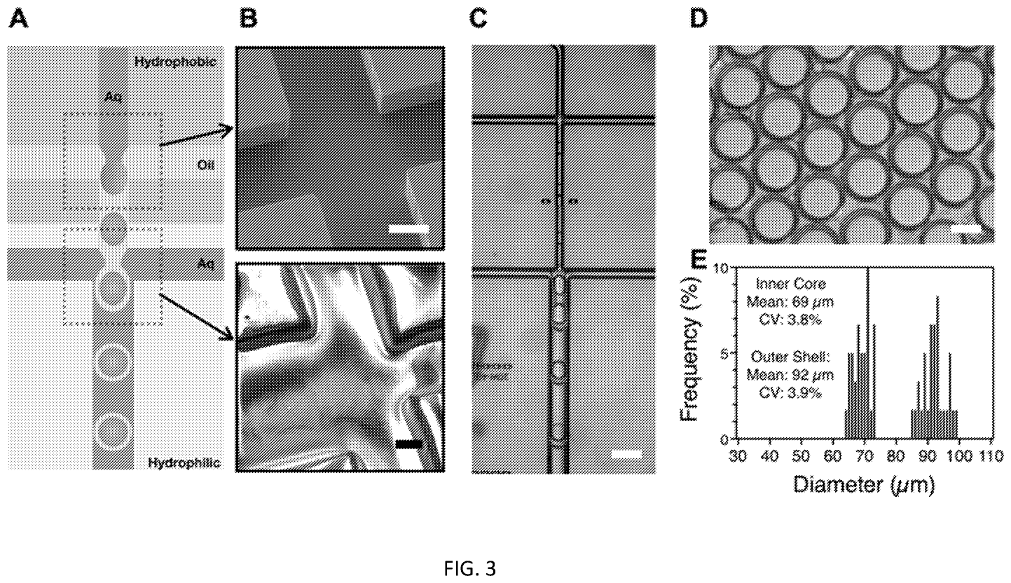

To demonstrate the versatility of our new patterning technique, we combine our lithographic patterning of silanes with our VLSMI fabrication method to fabricate chips that produce double emulsion (DEm) droplets; one can also fabricate Si and glass-based microfluidic chips using deep reactive ion etching (DRIE) for large-scale production of single emulsion droplets or compound gas bubbles. Two flow focusing generators are placed in series to generate double emulsions in dripping regime, in which droplets generated by the first generator are encapsulated in droplets generated by the second generator. For W/O/W double emulsion, the surface of the first junction is made hydrophobic such that the aqueous dispersed phase does not wet the channel surface. The second junction is made hydrophilic (FIG. 3A & 3B), such that the middle oil phase does not wet the channel surface. The first junction is modified to be hydrophobic using the patterning method described above. Because silicon and glass are natively hydrophilic, the second junction does not require surface modification. For O/W/O double emulsion, the opposite patterning of wettability is used; that is, the first junction is maintained to be hydrophilic while the remaining area is modified hydrophobic. The hydrophobicity of the glass wafer is patterned the same way and is later aligned and bonded with the silicon wafer by manually matching the alignment marks on the glass and silicon wafers.

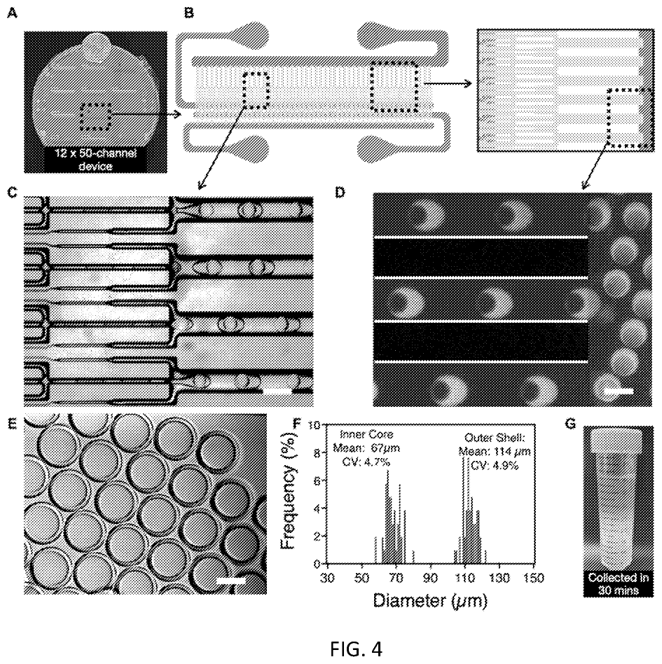

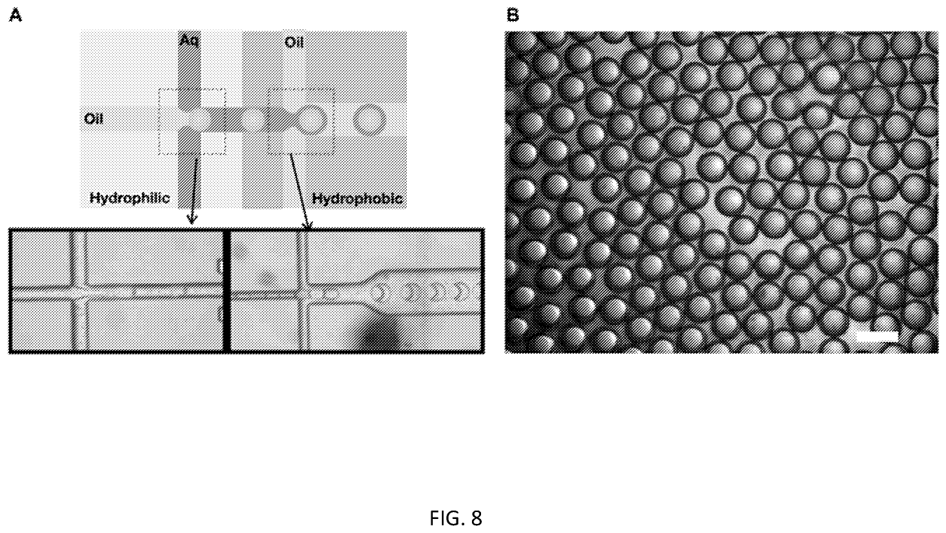

We evaluate an illustrative single double emulsion device's capability to generate precisely defined W/O/W double emulsion using DI water with 10 wt % of PVA as the outer phase, hexane with 2 wt % SPAN 80 as the middle oil phase, and DI water with 10 wt % PVA as the inner phase. The device is operated with flow rates of Qₒᵤₜ=1000 μl/hr, Q_{mid}=100 μl/hr and Qᵢₙ=200 μl/hr for the continuous, outer dispersed, and inner dispersed phases, respectively. By imaging the device during operation, we observe that the hydrophobic coating successfully prevents the dispersed phases from wetting the channel walls (FIG. 3C). As a negative control, we test a device that has an identical geometry but lacks hydrophobicity patterning and observe that the inner water phase wets the channel wall leading to the formation of an oil-in-water emulsion and unsuccessful formation of a double emulsion. The W/O/W double emulsion droplets generated from the patterned device have an inner core with an average diameter of 69 μm with a CV of 3.8%, and an average diameter of the outer core of 92 μm with a CV of 3.9% at a throughput of 300 μl/hr, (FIG. 3D 3&E) demonstrating highly homogeneous double emulsion formation with our patterned device. The same chip design with opposite surface patterning can be used for the generation of O/W/O double emulsions (FIG. 8). To demonstrate that this patterning strategy can be applied to a large area with high spatial resolution, we design a parallelized microfluidic chip with ladder geometry, containing a total of 50 double emulsion generators, each with precisely and identically patterned hydrophobicity (FIG. 4A-D).

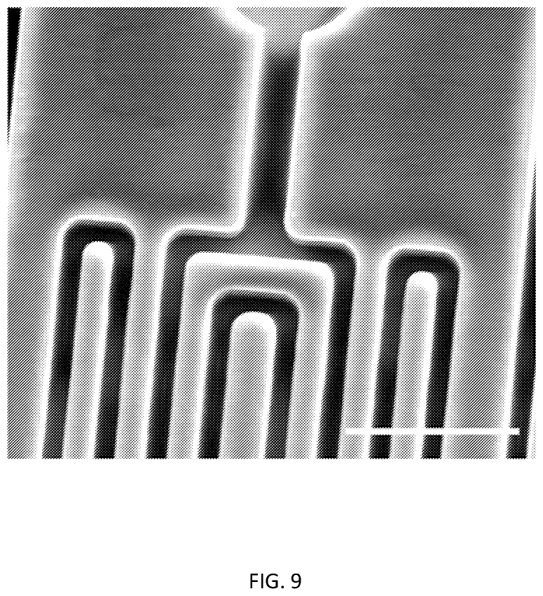

We apply a parallelization strategy to the generation of double emulsions. To satisfy the design rule,

$$2 N ( \frac{Rd}{Rdev} ) < 0.01 ,$$

where N is the number of droplet generating unit, R_{d} the resistance of the delivery channel, and R_{dev} the resistance of the droplet generating unit, flow resistors are incorporated upstream of each droplet generator to make the effective resistance of each droplet generator, R_{dev} much larger than that of the delivery channel between two droplet generators. This design ensures even flow of fluids into each droplet generator across the entire chip. Here, we provide example flow resistors to be 10 μm wide and 25 μm deep (FIG. 9), and delivery channel to be 400 μm wide and 200 μm deep, resulting in an

$$\frac{Rd}{Rdev} < 1 {0}^{- 5}$$

which allows an incorporation of up to N=1200 devices.

A design choice is to have through vias at the end of each emulsion generation unit connected to the collection channels on the backside of the chip. Such a design allows the integration of all of the fluidic connections to be on one side of the chip. However, to avoid destabilization of double emulsions, the collection channels are placed on the same side of the wafer as the double emulsion generators so that the double emulsion droplets flow into the deep collection channels without experiencing high shear stress (FIG. 4D). For hydrophobic patterning, we design long-stripe lithographic patterns that span over an entire row of drop generators, instead of individual box-shaped patterns on each drop generator (FIG. 4A) to facilitate alignment between the patterns on the glass and silicon wafers. We design alignment marks to aid the alignment between silicon and glass. These marks are both lithographically defined on the sides of the wafers; for silicon, these marks are etched with other layers, and for glass, thin layer (50 nm) of chromium is deposited through PVD (physical vapor deposition) to preserve these marks. This allows accurate alignment between the two wafers that has deviation around 100 μm (FIG. 9).

We characterize the performance of the 50-channel chip using the same dispersed and continuous phases as were used to test the single channel devices. The flow rates for the outer, middle, and inner phases are 50 mL/hr, 15 mL/hr, and 15 mL/hr, respectively. We observe that water-in-oil droplets are forming uniformly in all 50 of the devices, indicating that the hydrophobic silane coating remains functional after the chip bonding. Downstream, highly monodisperse W/O/W double emulsion droplets are formed in the natively hydrophilic downstream channels as shown in FIG. 4C-E. The double emulsion droplets have an inner core with an average diameter of 67 μm with a CV of 4.7%, and an average diameter of the outer core of 114 μm with a CV of 4.9%. Over 30 minutes, the device demonstrated stable operation and produced 15 mL (dispersed phases), corresponding to 4.76×10⁷, of double emulsions (FIG. 4G).

### Summary

We present a scalable arbitrary wettability patterning technique with micrometer-scale resolution that is compatible with very large-scale microfluidic integration (VLSMI) chips. The patterning technique takes advantages of robust photolithography process and utilizes an optimized micro-fabrication process that keeps silanized surfaces stable through the anodic bonding process. We demonstrate the technique by patterning microfluidic device for both W/O/W and O/W/O double emulsions, with inner diameters controlled over a range from 65 to 72 μm and outer diameters controlled over a range from 85 to 95 μm. The generated double emulsions show high uniformity with CV<5% for both the inner and outer diameters. The excellent solvent compatibility of Si/Glass allows this chip to be directly applied for making highly uniform double-emulsion templated microcapsules prepared using microfluidic devices. We further apply this technique to pattern a parallelized microfluidic chip with 50 double emulsion generating devices and achieve high throughput double emulsion generation at a production rate of 30 mL/hr (26.5 kHz). As an example, 20,000 generators can be integrated onto a 4-inch chip, and the throughput could potentially become 400 times of what is demonstrated in this work to 1.2 L/hr (10.6 MHz) if we scale the design to that level. This technology has broad utility of high-resolution patterning of wettability for applications that require stabilized flows of immiscible fluids such as lock-release lithography and the incorporation of functionalities such as phase inversion emulsification (PIE) to generate highly viscous emulsions. Furthermore, the technique can define microchannels with multiple wetting properties by functionalizing the surfaces with more than one type of silane, or other coupling agents. This enhanced control over wetting properties provides new classes of materials with highly-engineered structures and properties using multiphasic flows.

### Materials and Methods

Hydrophobic Patterning of the chip

The 3D-etched silicon wafer is conformally coated with 8 μm S1805 (MICROPOSIT) positive photoresist using a spray coater (SUSS Microtech AS8). The coated wafer is baked in a 90° C. oven for 2 mins. Angled exposures are performed 4 times on the wafer with an exposure energy of 1500 mJ/cm². In more detail, an ABM3000HR mask aligner is used for exposure. After placing the wafer and photomask on the mask aligner, the photomask chuck is tilted from one side to an angle of 15°, the wafer is aligned and made hard contact with the photomask, followed by exposure. Subsequently, the wafer and photomask are rotated 90°, while keeping the same side of the chuck tilted, and second exposure is performed (FIG. 6). This process is repeated two more times until the wafer and photomask turn back to the original position. The exposed wafer is then developed and dried in spin rinse dryer. The backside of the wafer (Delivery-channel side) is then spray-coated with 4 μm of S1805 (MICROPOSIT) photoresist so that only exposed channels are revealed throughout the entire wafer.

The wafer is subsequently placed in a silane vacuum chamber for vapor coating of trichloro (1H,1H,2H,2H-perfluorooctyl) silane (Sigma). Two drops (˜1 mL) of the silane solution are pipetted into a small plastic cup that is also placed in the chamber. The chamber vacuum is left overnight to complete the coating process. The wafer is subsequently washed in acetone, IPA, water and nanostrip to remove the photoresist.

### Single-Channel Silicon and Glass Chip Fabrication

The silicon and glass chip are fabricated via conventional photolithography and dry etching in the Singh Center for Nanotechnology. A 300 μm double-sided polished silicon wafer (University wafer, ID: 2345) is first coated with 6 μm thick SiO₂ film using PECVD. This oxide film is on the backside of the wafer and later serves as an etch stop for through silicon vias (TSVs). The front side is then patterned with the vias layer design. Briefly, 8 μm positive photoresist (S1805) is spray coated on the wafer, baked for 4 mins in 110° C., and exposed to 1500 mJ/cm² UV light. After development and hard bake, the wafer is cleaned in a spin rinse dryer, followed by through silicon etching using DRIE (deep reactive ion etching). This process is repeated for the droplet generator layer. 4 μm positive photoresist (S1805) is spray coated on the wafer, baked for 7 mins at 110° C., and exposed through a photomask to 165 mJ/cm² UV light. The wafer is then developed, hard baked and cleaned in the spin rinse dryer. Subsequently, the wafer is etched in DRIE for 50 μm deep. The etched wafer is then cleaned subsequently in acetone, IPA, and DI water, for 10 mins and finally nanostrip for 1 hour to remove the photoresist. The wafer is cleaned again in DI water and spin rinse dried. The 3D-etched silicon wafer is then spatially patterned for hydrophobicity following the steps in above paragraph (Hydrophobicity Patterning of the chip).

A 200 μm glass wafer (University wafer. ID: 2248) is spray coated with 4 μm positive photoresist and patterned for the alignment mark designs, following the same protocol as the droplet generator layer. 100 nm chromium is then deposited on the patterned wafer using physical vapor deposition (PVD). The wafer is subsequently washed in acetone for 10 mins to remove the photoresist, followed by subsequent cleaning in IPA and DI water. After spin rinse drying, the wafer is then spatially patterned for hydrophobicity, following the steps in above paragraph. Finally, the two cleaned wafers are aligned by hand using the alignment marks and stacked together. The wafer stack is anodically bonded using a wafer bonder (EVG-510) at 250° C., 1200 V for 10 mins. The bonded wafer is then diced by a dicing saw and ready to use for experiments.

### 50-Channel Parallel Silicon and Glass VLSMI Chip Fabrication

The 50-channel Siicon and Glass chip fabrication process is similar to the single-channel, with additional etching iterations to create the ladder geometry. The detailed fabrication protocol can be referred to our group's previous publication. Briefly, 300 μm double-sided polished silicon wafer (University wafer, ID: 2345) is first spary-coated with 8 μm S1805 photoresist, baked for 4 mins in an oven at 110° C., and exposed using a mask aligner (SUSS MA/BA6) with layer 1 design (delivery channels) and etched 150 μm deep using DRIE. The wafer is then cleaned subsequently in acetone, IPA, DI water and nanostrip for 10 mins each. The wafer is then immersed in DI water to remove nanostrip and dried in spin rinse dryer. After drying, the same side of the wafer is coated by 6 μm oxide layer in PECVD. After this, the wafer is flipped and patterned with layer 2 design (outlet channels) and etched 150 μm deep. This process is repeated for layer 3 (VIAs channels) and layer 4 (double emulsion generator channels), with an etching depth of 150 μm (through silicon etching), and 50 μm, respectively. The 3D-etched silicon wafer is then spatially patterned for hydrophobicity following the steps described in the section Hydrophobicity Patterning of the Chip.

A 200 μm glass wafer (University wafer. ID: 2248) is patterned for the alignment marks using the same way as described above in the single-channel fabrication section. A second 200 μm glass wafer is laser etched for 4 holes as the inlets and outlets for the fluids, with an excimer laser. After etching, the wafer is cleaned in acetone, IPA, DI water and nanostrip each for 10 mins, followed by another rinse in DI water. The wafer is then dried in SRD. The three cleaned wafers are aligned and stacked as a glass-silicon-glass triple stack. The stack is subsequently anodically bonded using a wafer bonder (EVG-510) at 250° C., 900 V for 10 mins, followed by another 10 mins with reserved polarity, at −1200V.

### Double Emulsion Generation (W/O/W and O/W/O)

For the formation of W/O/W double emulsion, the inner phase is composed of DI water with 10% PVA as surfactant. Hexane with 2% SPAN80 is used as the middle phase. For the outer phase, DI water with 10% PVA is used. In the case of O/W/O double emulsion, Hexadecane and 2% SPAN 80 is used for both the outer and inner phase. The middle phase is composed of DI water with 2% PVA. The composition is the same for both single-channel device and 50 channel chip.

### Contact Angle Measurement

The measurements of contact angles on different substrates are performed using a Tensiometer (Attension). For all the measurements, 50 μL of water drop is dispensed onto a substrate that is submerged in hexane. For each substrate, the measurement is repeated 3 times.

### Aspects

The following Aspects are illustrative only and do not limit the scope of the present disclosure or the appended claims. Any part or parts of any one or more Aspects can be combined with any part or parts of any one or more other Aspects.

Aspect 1. The present technology includes a method of forming a microfluidic component, comprising: disposing an agent onto at least a portion of a first substrate so as to define at least one relatively hydrophobic region on the first substrate, the first substrate comprising at least one of silicon and glass, the at least one relatively hydrophobic region of the first substrate having an initial hydrophobicity; anodically bonding the first substrate and a second substrate so as to give rise to the microfluidic component, the second substrate comprising at least one of silicon and glass and the bonding being performed under such conditions that that the at least one relatively hydrophobic region of the first substrate retains at least some of its initial hydrophobicity.

As illustrated, the disclosed methods can be applied to bonding a silicon substrate to a glass substrate, e.g., with the silicon substrate being the first substrate and the glass substrate being the second substrate.

Aspect 2. The method of Aspect 1, wherein the anodic bonding comprises heating at less than about 300° C.

Aspect 3. The method of Aspect 2, wherein the anodic bonding comprises heating at less than about 250° C., less than about 225° C., less than about 200° C., less than about 175° C., or even less than about 150° C.

Aspect 4. The method of any one of Aspects 1-3, wherein the bonding comprises applying a voltage of from about 600 to about 1200 V.

Aspect 5. The method of Aspect 4, wherein the anodic bonding comprises voltage of from about 850 to about 950 V.

Aspect 6. The method of any one of Aspects 1-5, wherein the agent that is disposed onto the first substrate can be relatively hydrophobic relative to the first substrate.

Aspect 7. The method of Aspect 6, wherein the agent is a silane.

Aspect 8. The method of Aspect 7, wherein the silane is trichloro (1H,1H,2H,2H-perfluorooctyl) silane (PFOCTS); other example silanes include perfluoro decyl silane and perfluorooctyltriethoxysilane.

Aspect 9. The method of any one of Aspects 1-8, further comprising disposing an agent onto at least a portion of the second substrate so as to define at least one relatively hydrophobic region on the second substrate, the at least one relatively hydrophobic region of the second substrate having an initial hydrophobicity.

Aspect 10. The method of Aspect 9, wherein the at least one relatively hydrophobic region of the second substrate can retain at least some of its initial hydrophobicity (e.g., at least 50%) after the anodic bonding.

As an example, the hydrophobic region of the second substrate can give rise to a water contact angle of X° before bonding and a contact angle that is at least 0.5X (and up to X) following the bonding. The difference in post-bonding contact angle can be less than 50°, less than 45°, less than 40°, less than 35°, less than 30°, less than 25°, less than 20°, less than 15°, less than 12°, less than 10°, less than 8°, less than 6°, less than 5°, less than 4°, less than 3°, less than 2°, or even less than 1°. Such contact angles can be measured by, e.g., opening a bonded device so as to access the relatively hydrophobic region for further contact angle measurements.

Aspect 11. The method of any one of Aspects 9-10, wherein the relatively hydrophobic region of the first substrate and the at least one relatively hydrophobic region of the second substrate face one another after the anodic bonding, e.g., as shown in FIG. 1A, stage 6.

Aspect 12. The method of any one of Aspects 1-11, wherein the first substrate has a concavity formed therein, the concavity having a side and a bottom, and the agent being disposed on the side and the bottom of the concavity.

Aspect 13. The method of Aspect 12, wherein the concavity is a channel. The concavity can also be, for example, a depression, and the like.

Aspect 14. The method of Aspect 13, wherein the agent is disposed on the first substrate and also on the second substrate such that the agent is present on a ceiling, a side, and a bottom of a channel. This is shown in, e.g., FIG. 1A, stage 6.

Aspect 15. The method of any one of Aspects 1-14, wherein the component is configured as a droplet generator.

Aspect 16. The method of Aspect 15, wherein the component is configured as an emulsion generator.

Aspect 17. The method of Aspect 16, wherein the component is configured as a double emulsion generator.

Aspect 18. The method of Aspect 16, wherein the component is configured as a triple emulsion generator, or as a generator of another multiple emulsion. The microfluidic component can also be configured as an emulsion inverter.

Aspect 19. The method of any one of Aspects 1-18, wherein the microfluidic component defines a first channel defined by relatively hydrophobic surfaces and a second channel defined by relatively hydrophilic surfaces, the first channel and the second channel in fluid communication with one another. This is shown in, e.g., FIG. 1B.

Aspect 20. The method of any one of Aspects 1-19, wherein the at least one relatively hydrophobic region on the first substrate defines a width of less than about 100 μm.

Aspect 21. The method of Aspect 20, wherein the at least one relatively hydrophobic region on the first substrate defines a width of less than about 50 μm.

Aspect 22. The method of Aspect 21, wherein the at least one relatively hydrophobic region on the first substrate defines a width of less than about 10 μm.

Aspect 23. The method of Aspect 22, wherein the at least one relatively hydrophobic region on the first substrate defines a width of less than about 5 μm.

Aspect 24. The method of Aspect 23, wherein the at least one relatively hydrophobic region on the first substrate defines a width of less than about 1 μm.

The region can be a line (straight or curved), a dot, or other shape.

Aspect 25. The method of any one of Aspects 1-24, further comprising application of a photoresist to the substrate, the application optionally comprising spin coating.

Aspect 26. The method of Aspect 25, further comprising removing the photoresist by application of illumination, e.g., by the illumination being delivered at an angle relative to a line drawn orthogonal to the substrate.

Aspect 27. The method of Aspect 26, wherein the agent (which can be, e.g., a silane) can be disposed onto a region of the substrate that is essentially free of photoresist.

A photomask can be used to control the locations to which the illumination is applied. By application and removal of the photoresist, the user can give rise to a pattern (e.g., lines) of exposed substrate to which a user can apply an agent, e.g., a hydrophobic agent such as a silane.

Aspect 28. The disclosed technology also includes a microfluidic component made according to the described methods, e.g., according to any one of Aspects 1-27.

Aspect 29. A microfluidic component, comprising: a first substrate, the first substrate optionally comprising silicon, the first substrate having a feature formed therein, the feature optionally comprising a channel, and the feature having at least one region that is relatively hydrophobic relative to the first substrate; a second substrate, the second substrate being bonded to the first substrate, the second substrate optionally comprising glass, the second substrate having at least one region that is relatively hydrophobic relative to the second substrate, and the relatively hydrophobic region of the first substrate facing the relatively hydrophobic region of the second substrate.

In some embodiments, one of the first substrate and the second substrate is silicon, and the other of the first substrate and the second substrate is glass.

Aspect 30. The microfluidic component of Aspect 29, wherein the feature of the first substrate is a channel having a top, a bottom, and sides, wherein the top of the channel is relatively hydrophobic compared to the second substrate, and wherein the bottom and sides of the channel are relatively hydrophobic compared to the first substrate. Such a channel is shown in FIG. 1A (step 6), which channel has silane (hydrophobic agent) present at the channel's top, bottom, and sides.

Aspect 31. The microfluidic component of Aspect 29, wherein the first substrate defines a plurality of features (e.g., channels) formed in a first surface of the first substrate and a plurality of features (e.g., channels) formed in a second surface of the first substrate.

Aspect 32. The microfluidic component of Aspect 31, further comprising at least one channel (e.g., a via) that places a feature formed in the first surface of the first substrate into fluid communication with a feature formed in the second surface of the first substrate. Such an arrangement is shown in FIG. 1A.

Aspect 33. The microfluidic component of any one of Aspects 29-32, wherein the microfluidic component is configured as a droplet generator.

Aspect 34. The microfluidic component of Aspect 33, wherein the microfluidic component is configured as an emulsion generator.

Aspect 35. The microfluidic component of Aspect 34, wherein the microfluidic component is configured as a double emulsion generator.

Aspect 36. The microfluidic component of Aspect 34, wherein the microfluidic component is configured as a triple emulsion generator; the microfluidic component can also be configure as another multiple emulsion generator.

The microfluidic component can also be configured as an emulsion inverter. Exemplary components are shown in, e.g., FIG. 1B and 1C. As shown in FIG. 1C, a component can include tens, hundreds, or even thousands of droplet generators, thereby allowing for massively parallel production of droplets, e.g., as emulsions.

Aspect 37. The microfluidic component of any one of Aspects 29-36, wherein the microfluidic component defines a first channel defined by relatively hydrophobic surfaces and a second channel defined by relatively hydrophilic surfaces, the first channel and the second channel in fluid communication with one another.

Aspect 38. The microfluidic component of any one of Aspects 29-37, wherein the least one relatively hydrophobic region on the first substrate defines a width of less than about 100 μm.

Aspect 39. The microfluidic component of Aspect 38, wherein the least one relatively hydrophobic region on the first substrate defines a width of less than about 50 μm.

Aspect 40. The microfluidic component of Aspect 39, wherein the least one relatively hydrophobic region on the first substrate defines a width of less than about 10 μm.

Aspect 41. The microfluidic component of Aspect 40, wherein the least one relatively hydrophobic region on the first substrate defines a width of less than about 5 μm.

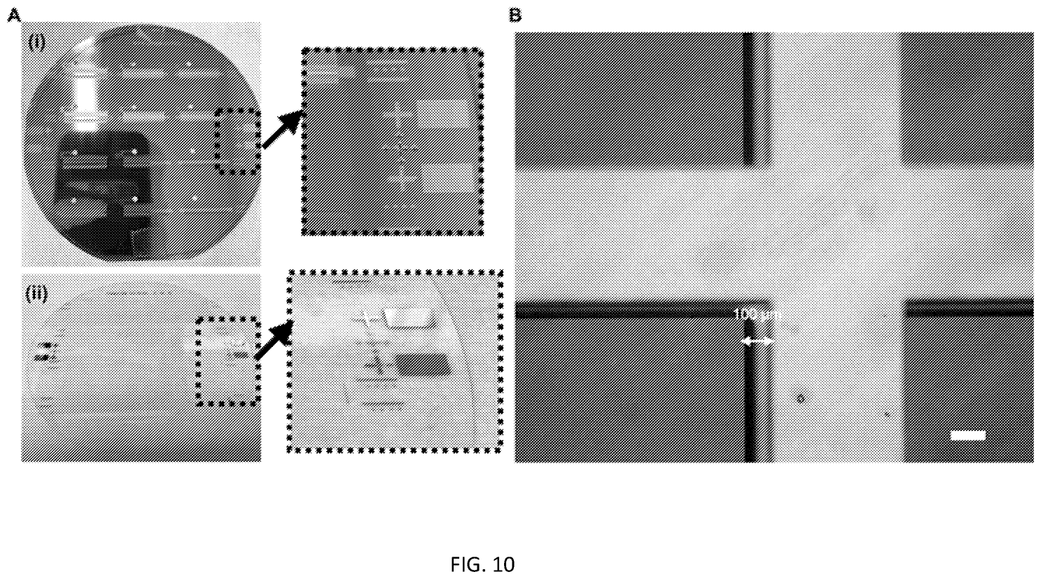

Aspect 42. The microfluidic component of Aspect 41, wherein the least one relatively hydrophobic region on the first substrate defines a width of less than about 1 μm. An exemplary such component is shown by, e.g., FIG. 10 and FIG. 11.

Aspect 43. The microfluidic component of any one of Aspects 29-42, wherein the microfluidic component comprises a first channel in fluid communication with a first fluid and a channel in fluid communication with second fluid that is immiscible with the first fluid. This can be done, e.g., when the microfluidic component is used as an emulsion generator.

Also provided are methods, the methods including using a microfluidic component according to the present disclosure, e.g., according to any one of Aspects 28-42. The use can be for, e.g., droplet generation, such as generation of an emulsion.

1. A method of forming a component, comprising:
disposing an agent onto at least a portion of a first substrate so as to define at least one relatively hydrophobic region on the first substrate,
the first substrate comprising at least one of silicon and glass,
the at least one relatively hydrophobic region of the first substrate having an initial hydrophobicity:
anodically bonding the first substrate and a second substrate so as to give rise to a component,
the second substrate comprising at least one of silicon and glass and
the bonding being performed under such conditions that that the at least one relatively hydrophobic region of the first substrate retains at least some of its initial hydrophobicity.

2. The method of claim 1, wherein the anodic bonding comprises at least one of heating at less than about 300° C. or applying a voltage of from about 600 to about 1200 V.

3. (canceled)

4. (canceled)

5. (canceled)

6. The method of claim 1, wherein the agent is relatively hydrophobic relative to the first substrate, the agent optionally comprising a silane.

7. (canceled)

8. (canceled)

9. The method of claim 1, further comprising disposing an agent onto at least a portion of the second substrate so as to define at least one relatively hydrophobic region on the second substrate, the at least one relatively hydrophobic region of the second substrate having an initial hydrophobicity, optionally wherein (1) the at least one relatively hydrophobic region of the second substrate retains at least some of its initial hydrophobicity after the anodic bonding. (2) the at least one relatively hydrophobic region of the first substrate and the at least one relatively hydrophobic region of the second substrate face one another after the anodic bonding, or both (1) and (2).

10. (canceled)

11. (canceled)

12. The method of claim 1, wherein the first substrate has a concavity formed therein, the concavity having a side and a bottom, and the agent being disposed on the side and the bottom of the concavity, the concavity optionally comprising a channel.

13. (canceled)

14. The method of claim 12, wherein the concavity comprises a channel and wherein the agent is disposed on the first substrate and the second substrate such that the agent is present on a ceiling, a side, and a bottom of the channel.

15. The method of claim 1, wherein the microfluidic component is configured as a droplet generator.

16. The method of claim 15, wherein the microfluidic component is configured as an emulsion generator, optionally wherein the microfluidic component is configured as a double emulsion generator or a triple emulsion generator.

17. (canceled)

18. (canceled)

19. The method of claim 1, wherein the microfluidic component defines a first channel defined by relatively hydrophobic surfaces and a second channel defined by relatively hydrophilic surfaces, the first channel and the second channel in fluid communication with one another.

20. The method of claim 1, wherein the at least one relatively hydrophobic region on the first substrate defines a width of less than about 100 μm, optionally less than about 50 μm, optionally less than about 10 μm. optionally less than about 5 μm, optionally less than about 1 μm.

21. (canceled)

22. (canceled)

23. (canceled)

24. (canceled)

25. (canceled)

26. (canceled)

27. (canceled)

28. (canceled)

29. A microfluidic component, comprising:
a first substrate,
the first substrate optionally comprising silicon,
the first substrate having a feature formed therein, the feature optionally comprising a channel, and
the feature having at least one region that is relatively hydrophobic relative to the first substrate:
a second substrate,
the second substrate being bonded to the first substrate,
the second substrate optionally comprising glass,
the second substrate having at least one region that is relatively hydrophobic relative to the second substrate, and
the relatively hydrophobic region of the first substrate facing the relatively hydrophobic region of the second substrate.

30. The microfluidic component of claim 29, wherein the feature of the first substrate is a channel having a top, a bottom, and sides, wherein the top of the channel is relatively hydrophobic compared to the second substrate, and wherein the bottom and sides of the channel are relatively hydrophobic compared to the first substrate.

31. The microfluidic component of claim 29, wherein the first substrate defines a plurality of features formed in a first surface of the first substrate and a plurality of features formed in a second surface of the first substrate.

32. The microfluidic component of claim 31, further comprising at least one channel that places a feature formed in the first surface of the first substrate into fluid communication with a feature formed in the second surface of the first substrate.

33. The microfluidic component of claim 29, wherein the microfluidic component is configured as a droplet generator.

34. The microfluidic component of claim 33, wherein the microfluidic component is configured as an emulsion generator.

35. The microfluidic component of claim 34, wherein the microfluidic component is configured as at least one of a double emulsion generator or a triple emulsion generator.

36. (canceled)

37. The microfluidic component of claim 29, wherein the microfluidic component defines a first channel defined by relatively hydrophobic surfaces and a second channel defined by relatively hydrophilic surfaces, the first channel and the second channel in fluid communication with one another.

38. The microfluidic component of claim 29, wherein the at least one relatively hydrophobic region on the first substrate defines a width of less than about 100 μm, optionally less than about 50 μm, optionally less than about 10 μm, optionally less than about 5 μm. optionally less than about 1 μm.

39. (canceled)

40. (canceled)

41. (canceled)

42. (canceled)

43. The microfluidic component of claim 29, wherein the microfluidic component comprises a first channel in fluid communication with a first fluid and a channel in fluid communication with second fluid that is immiscible with the first fluid.
